(19) United States
(12) Patent Application Publication
(10) Pub. No.: US 2004/0083122 A1
(43) Pub. Date: Apr. 29, 2004

(54) Human service coordination via telecommunications

(76) Inventors: Bradley Paul Allen, Shorewood, WI (US); Stephanie Ann Allen, Shorewood, WI (US)

Correspondence Address: Bradley P. Allen, 4508 N. Bartlett Ave., Shorewood, WI, 53211, US

(21) Appl. No.: 10/244,179

(22) Filed: Oct. 24, 2002

(51) Int. Cl. G06F 17/60

(52) U.S. Cl. 705/2

(57) ABSTRACT

The present invention is a system and method for facilitating an interdisciplinary process of care for people residing either in community-based programs or in-patient residential settings such as mental health facilities, facilities for the developmentally disabled, intermediate care facilities or nursing homes. The system establishes a process by which consultants (or vendors) are able to electronically communicate with a centralized information specialist in order to establish and maintain an interdisciplinary plan of care for individuals with special needs. An information specialist electronically provides the consultants with data, documentation, reports and other relevant materials for their review. The consultants review the information and render recommendations specific to their area of expertise. The information specialist complies, organizes and formats the consultants' recommendations into an interdisciplinary plan of care stored in an electronic space accessible only by persons or parties providing care to the individual.

### FILED OF THE INVENTION

The present invention relates to a system and method for facilitating interdisciplinary care for individuals with special needs residing in residential facilities or community based agencies who would not otherwise receive such services due to time, distance and/or financial constraints. Specifically, the present invention involves creating interdisciplinary plans of care effectively and efficiently, by utilizing an electronic process of information exchange.

### BACKGROUND OF INVENTION

In responding to recent nursing home closings, the Executive Director of Wisconsin Health Care Association, Tom Moore, responded, “. . . as indicated by the numbers, the situation is very critical . . .” (THE MILWAUKEE JOURNAL SENTINEL, West Allis Nursing Home to Shut Down in Spring, Jan. 2, 2002). Over the past 2 years, 23 Wisconsin nursing homes have closed and of those remaining, 14% are operating under bankruptcy protection. These numbers are indicative of the main difficulties currently confronting the nursing home industry: 1) Medicaid rates that don't cover the entire cost of resident care and 2) an inability to recruit and retain qualified staff. In short, nursing homes are being challenged to provide the same level of care with fewer and fewer resources. In a report issued by Wisconsin's Department of Health and Family Services, the trend over the years has been a decline in Medicare and private pay admissions to nursing homes with an increase in Medicaid funded residents.

In addition to a decline in reimbursement rates, nursing homes are also experiencing high staff turnover and increased demands on staff time for “direct care” of residents. Thus, nursing homes are being challenged to provide more services for less compensation. To further complex this already bleak scenario, the needs of nursing home residents are changing. The primary diagnoses include more and more people with primary psychological and behavioral needs. For example, more than a third of nursing home residents in the year 2000 had mental disorders as their primary diagnosis and over 40% had cardiovascular or cerebrovascular disease. Thus, the main issue becomes how are nursing homes going to continue to produce services for more complex residents with fewer financial resources. One approach, as offered by this proposal, may be to utilize a combination of multidisciplinary and multimodal processes delivered via an electronic format. The advantages to this model of service delivery would be its cost effectiveness resulting from a more efficient use of staff resources. The following sections will examine the molecular design to service provision and a process which utilizing electronic communication between the service coordinator and vendors/sub-contractors.

In the world of business, there has been a shift, or perhaps more accurately, an evolution, of ideas on how organizations should be structured to provide for the needs of their customers (Ross and Kay, 1994. Toppling the Pyramids). Historically, businesses tended to be organized in a hierarchical or pyramidal structure, with the executives being on the top, middle management comprising the next level, and production being at the bottom. Although this structure proved useful during times of relative economic stability, it became cumbersome when quick decisions or rapid responses were required to respond to customers' needs. The necessity of businesses responding more quickly to consumer needs became even more prevalent as foreign competition increased. Additionally, as products became much more customer-oriented, businesses needed to respond quickly to ever-changing consumer preferences. Consequently, the structures of business began to change so that the emphasis shifted from a pyramidal to a molecular organization model.

The molecular organizational model is a multi-component system, connected together by common bonds. A primary component of this model is the supervisor who works from a central location (the nucleus) and oversees the individual operating units (the electrons) actually providing the services/goods to the customer. Middle management (the bonds) in this structure functions to coordinate the central office and operating units together.

Although this explanation tends to be a somewhat simplistic overview of a dynamic model, it is intended as a general description of the principle of molecular organization and its possible applications to human services. That is, based upon the human service goals of person-centeredness, multidimensional and interdisciplinary, the molecular organizations would appear to be an effective and efficient manner in which to deliver these services.

More specifically, this model encompasses the philosophy of current human service provision while maintaining the important characteristics of person-centeredness, and multidimensional (or multimodal) approaches based upon a foundation of common or shared values. As could be anticipated, however, there will be some slight modifications in its application. Instead of the “boss” being “the center”, this will be where the consumer of the services would be located. The service providers or support people would be in the surrounding units or “electrons”. The team coordinator or case manager would take on the role of middle-management and bind the parts together by facilitating communication between the parts and focusing their efforts on shared values and beliefs. As mentioned previously, this configuration will enable the model to expand and contract, based upon the consumer's needs and desires, without destroying the whole.

Although the molecular model is an efficient and effective means by which to deliver goods and services to customers, a major drawback is the extensive coordination that it requires. That is, the organization of the various components can be very time consuming and in some cases, extremely cumbersome. Specific to human services, the case manager would be constantly challenged to ensure that all the service providers and customers were communicating or “connected” and that this process was a seamless and constant exchange of information.

The widespread use of electronic communication, specifically the Internet, has made it possible to apply the molecular business model to human services. The use of electronic communications and Internet has allows human service providers to electronically meet with specialists/consultants, obtain and distribute information, interact to design and implement care plans and disseminate the care plans to the direct care givers. In a sense, the Internet allows for interdisciplinary team planning via electronic communication which and enables the human service provider to maintain the molecular business design without an unreasonable expenditure of resources.

It has long been recognize in human services that the most effective care is interdisciplinary and multimodal. The use of the Internet provides for an interdisciplinary and multimodal plan of care organized upon the molecular design.

Once the care plan is written it can be accessed by designated persons providing the care to the clients with special needs. The plans may be stored on a secured data storage device and accesses from any computer terminal with Internet capability.

### SUMMARY OF THE INVENTION

The present invention is a system and method for facilitating an interdisciplinary process of care for people residing either in community-based programs or in-patient residential settings such as mental health facilities, facilities for the developmental disabled, intermediate care facilities or nursing homes.

The system establishes a process by which consultants (or vendors) are able to electronically communicate with a centralized information specialist in order to establish and maintain an interdisciplinary plan of care for individuals with special needs. The information specialist may be an employee of the facility or agency or an independent party contracted for such services by the care facility or agency.

The information specialist electronically provides the consultants with data, documentation, reports and other relevant materials for their review. The consultants review the information and render recommendations specific to their area of expertise. The information specialist complies, organizes and formats the consultants recommendations into an interdisciplinary plan of care.

The final plan is electronically returned to each vendor/consultant for final review and comments. After receiving final comments, the information specialist formats the information into a plan of care and stores it in a secure electronic space accessible only by persons or parties providing care to the individual.

The care providers use the report in planning and implementing services for the individual. The process is repeated regularly to update and revise as goals are met and new service needs arise.

### BRIEF DESCRIPTION OF DRAWINGS

FIG. 1 depicts a block diagram illustrating the process by which information is exchanges, stored and disseminated.

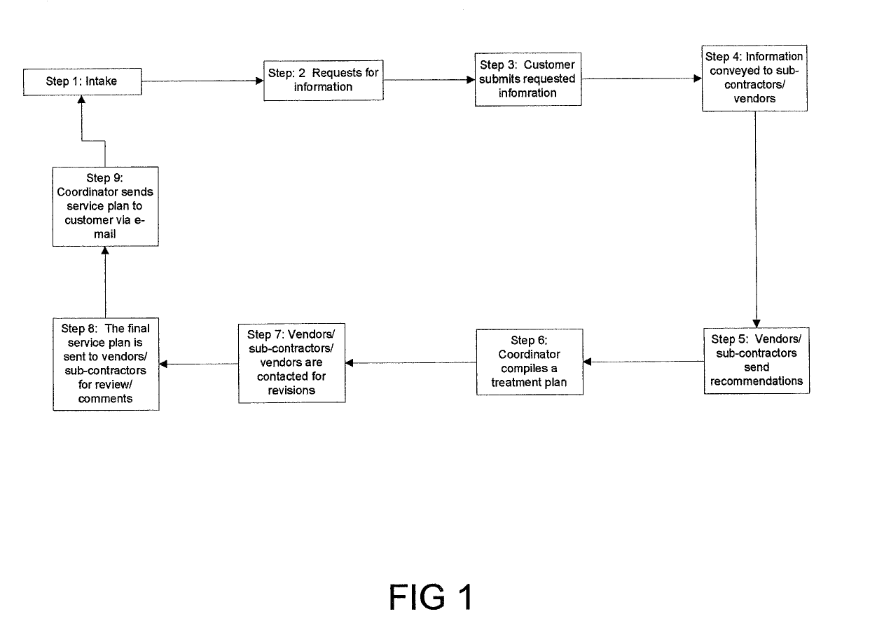

FIG. 2 depicts a diagram illustrating an example of how the molecular model may be applied to human service provision.

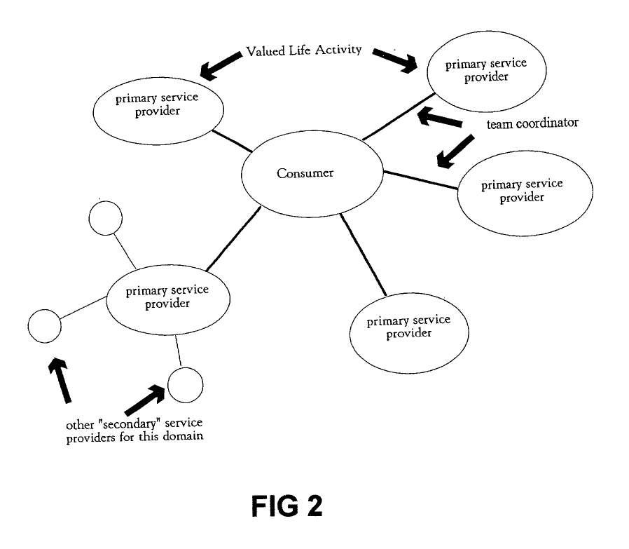

### DETAILED DESCRIPTION OF THE PRESENT INVENTION

The first step in the process is the customer sending referral information to the information specialist. This can be in the format of a form, application, specified document, etc., so that the information specialist is able to make judgments about the person's general needs and what additional information the vendors/consultants will require. This exchange will occur using the Internet.

After receiving the intake or registration information, the information specialist will recommend an assessment pathway which can include standardized or pre-existing forms, screening tools, or evaluation procedures. For example, if the person with special needs is experiencing memory changes, the information specialist may request that a Mini Mental State Exam be conducted and the results sent to the information specialist.

After the customer completes preliminary assessment in step 3, he/she submits the information to the information specialist via electronic mail.

The information specialist then places the information into an electronic patient folder and notifies the vendor/consultants that it is available for their review. The access to the folder is restricted to the information specialist and the vendors.

The vendor/consultants review the information and submit recommendations into designated electronic folders at the designated site.

The information specialist reviews the information and compiles them into a interdisciplinary plan of care and places it into a folder at the designated site. He/She then notifies the vendor/consultants that it is available for their review.

The information specialist then integrates the revisions into the plan and again place it into a designated folder. The vendor/consultants are contacted for their final review and approval.

After plan is finalized, it is placed into a secured website and the customer is notified that he/she may access it with specified code.

1. A system and method for facilitating an interdisciplinary process of care for people residing either in community-based programs or in-patient residential settings such as mental health facilities, facilities for the developmental disabled, intermediate care facilities or nursing homes comprising: a) the electronic exchange of information between an information specialist and consultants to obtain, compile and format information into and interdisciplinary plan of care; and b) a business rule to store and access the plan of care by persons providing direct care to the individual for which the plan was written.

2. The method of claim 1, wherein the communication and/or exchange media is the Internet, an Intranet or electronic storage devices such as compact disks, computer diskettes, audio tapes, video tapes, or telephone voice mail.

3. The method of claim 1, wherein the business rule is created by the company or individual creating the plan of care in compliance with all applicable state and federal regulations regarding confidentiality and informed consent.

4. The method of claim 3, the business rule is either stored in or attached to the data storage device.

5. The method of claim 1, wherein the member user is a group care provider user or an individual care provider.

6. The method of claim 5, wherein the care provider is a care facility or agency where the individual is receiving services, the business rule grants access to the treatment plan to specified individual care plans consistent with the policies and procedures of the facility.

7. The method of claim 6, wherein the care provider is a care facility or agency, the business rule grants authority to a designated representative to determine and grant access privileges to at least one individual care provider.

8. The method of claim 7, further includes receiving a business rule from the representative of the facility or agency granting access to at least one care provider.

9. The method of claim 1, wherein the care plan is paced into a designated file on a data storage device with other separate files established for information provided by the consultants/vendors including: medical information; assessments of physical, adaptive, cognitive, social, recreational functioning, vocational, emotional, psychological, and psychiatric functioning; personal history; educational records; dietary evaluations; evaluations of adaptive devices; nursing evaluations; and medication evaluations.

10. The method of claim 1, wherein the data storage and care plan includes at least one of text, audio, photos, graphics and/or audiovisual items.

11. The method of claim 1, wherein the business rule is created at the time that the cared-for individual and/or legal representative consents to an interdisciplinary plan of care.

12. The method of claim 1, further includes contracting for services with individual consultants or vendors who then provide an e-mail address which is stored in the data storage device by the information specialist.

13. The method of claim 12, further includes: authorizing a representative of the care facility or agency to solicit, negotiate and enter into contracts with individual care consultants/vendors.

14. The method of claim 13, further provides: providing the cared-for individual and/or responsible party with a list of contracted care consultant/vendors.

15. The method of claim 1, wherein the business rule is one of read only, change or none.

16. The method of claim 1, the electronic interdisciplinary team process comprises: a server connected to a communication media, the server accessible by a plurality of interface devices connected to the communication media; and at least one business rule on how the information is to be obtained, exchanged and disseminated.

17. The system of claim 16, wherein the communication media is a local area network or a wide area network.

18. The system of claim, 16, wherein the business rule is created by the facility or agency providing care for the individual.

19. The system of claim 16, wherein the business rule is transmitted from the user interface device to the server and stored in a data storage device connected to the server.

20. A method for providing interdisciplinary care to individuals with special needs by utilizing electronic communication to compile, organize and format information into an interdisciplinary plan of care: a) information is conveyed to care consultants/vendors; b) care consultants/vendors electronically submit recommendations; c) information specialist processes information into an interdisciplinary plan of care; d)care plan is disseminated to care provider(s) who are granted access to a data storage device; e) plan is reviewed and revised as needed; f) business rules are created by care providers.
